(19) United States
(12) Patent Application Publication
(10) Pub. No.: US 2026/0229904 A1
(43) Pub. Date: Aug. 6, 2026

(54) WEARABLE BATTERY SYSTEM FOR POWERING A TOOL

(71) Applicant: Legion Innovations, LLC, Federal Way, WA (US)

(72) Inventors: Hoan P. Tran, Federal Way, WA (US); Mario Alberto Rodriguez Perez, Arlington, WA (US); Andreas Rodriguez Perez, Arlington, WA (US)

(21) Appl. No.: 19/529,638

(22) Filed: Feb. 4, 2026

Related U.S. Application Data
(60) Provisional application No. 63/754,384, filed on Feb. 5, 2025.

(51) Int. Cl. H02J 7/47; H01M 10/44; H02J 7/44; H02J 7/70; H02J 7/90; H02J 7/94; H02J 7/96

(52) U.S. Cl. CPC H02J 7/47; H01M 10/44; H02J 7/44; H02J 7/751; H02J 7/933; H02J 7/94; H02J 7/96; H02J 7/975

(57) ABSTRACT

Provided is a wearable battery system including battery and connectors and a system controller. The controller polls for a connection with a tool, receives a device identifier of the tool and determines whether the device identifier corresponds to a stored device identifier of the plurality of stored device identifiers. In response to determining that the device identifier does not correspond to the stored identifier, the controller refrains from powering the tool and in response to determining that the device identifier corresponds to the stored device identifier, the controller retrieves the voltage level and the current level associated with the stored device identifier, sets an output voltage of the wearable battery system to the voltage level associated with the stored device identifier and an output current of the wearable battery system to the current level associated with the stored device identifier and powers the tool from the battery(ies).

### BACKGROUND

### Technical Field

The present disclosure relates to a battery system for powering a tool and, more particularly, to a wearable system that adapts a voltage and an amperage supplied to the device based on the requirements of the device.

### Description of the Related Art

Tools are ubiquitous in many industries, including automotive, construction, gardening, mining, manufacturing, sports, and medical industries. The type of a tool typically depends on its power source, which may be electrical, pneumatic, liquid fuel or hydraulic, among others. Power tools reduce the time and labor requirements in many applications, especially as related to redundant tasks.

Traditional electric tools employ motors that require alternating electric current, which necessitates plugging into a wall socket during use. Power tools have evolved to using direct current (provided by portable batteries) with each individual tool having its own battery to deliver a specific current and voltage. While batteries can be charged and swapped during use to provide near uninterrupted use, a battery for one tool may not be used for another power tool. In addition, the battery may be attached to the power tool, which adds weight and makes the tool cumbersome to operate.

Corded power tools may operate continuously (without the need to charge or recharge a battery) so long as they are connected to a power source. However, corded tools are associated with tripping hazards in work environments. In addition, cords are susceptible to becoming tangled, which is detrimental to safety. At the beginning and end of use, cord management takes time and can decrease workflow efficiency of a project. Corded power tools are also tethered to an outlet, reducing the versatility and mobility of the tool. Adding an extension cord increases the tripping hazard of the tool. Further, cords can become frayed or loosen from the tool or outlet and cause electric injury.

In various industries, cordless tools have a battery attached to the tool. Cordless power tools were initially designed with a low operating voltage. However, they are increasingly designed with higher voltages that can reach 60 volts (V). As the voltage increases, the size of the battery also increases to enable delivering a stable voltage over a sustained period of time. Cordless tools make work environments safer. However, larger motors necessitate large batteries, which upsets the weight balance of tools, making them difficult to weld, heavier, and less ergonomic.

In a surgical environment, electric tools are typically corded and attached to a power box, which is plugged into a wall outlet. Further, different tools, such as electrocautery and hand drills, are plugged into different power boxes. The lack of power box compatibility makes surgeries even more cumbersome as most surgeries require more than one tool, leading to cords being passed off the sterile surgical field into their own individual power box. Some drills and saws that are used in orthopedic surgeries are cordless. However, the inclusion of a battery in the tool makes the instrument heavier and more difficult to use for a sustained period of time. Additionally, batteries have to undergo a harsh sterilization process, diminishing the expected battery life. In addition, the batteries are tool-specific, and the battery of one tool may be incompatible with another tool.

### BRIEF SUMMARY

Provided is a wearable battery system for powering a tool, such as an electromotive or electronic tool. The wearable battery system includes a tool connector positioned on a wearable garment. The tool connector interfaces with the tool. The wearable battery system detects power requirements (e.g., current and voltage) of the tool and delivers the power requirements to the tool.

Provided is a wearable battery system including battery and connectors and a system controller. The controller polls for a connection with a tool, receives a device identifier of the tool and determines whether the device identifier corresponds to a stored device identifier of the plurality of stored device identifiers. In response to determining that the device identifier does not correspond to the stored identifier, the controller refrains from powering the tool and in response to determining that the device identifier corresponds to the stored device identifier, the controller retrieves the voltage level and the current level associated with the stored device identifier, sets an output voltage of the wearable battery system to the voltage level associated with the stored device identifier and an output current of the wearable battery system to the current level associated with the stored device identifier and powers the tool from the battery(ies).

### BRIEF DESCRIPTION OF THE SEVERAL VIEWS OF THE DRAWINGS

FIG. 1 shows an example of an environment in which a wearable battery system is used.

FIG. 2 shows a block diagram of the wearable battery system.

FIG. 3A shows a top view of a connector of the wearable battery system in accordance with an embodiment.

FIG. 3B shows a cross-sectional view of the connector and an opposite polarity connector in accordance with an embodiment.

FIG. 4 shows a flow diagram of a method for operating the wearable battery system in accordance with an embodiment.

FIG. 5 shows a flow diagram of a method for operating the wearable battery system in accordance with an embodiment.

FIG. 6 shows an example of a list of device identifiers retained by a system controller of the wearable battery system.

FIG. 7A shows a top view of a belt having a battery connector and a housing of the wearable battery system attached thereto.

FIG. 7B shows a top view of the belt of FIG. 7A having batteries coupled thereto.

FIG. 7C shows a cross-sectional view of a battery.

FIG. 8 shows a simplified block diagram of a tool.

### DETAILED DESCRIPTION

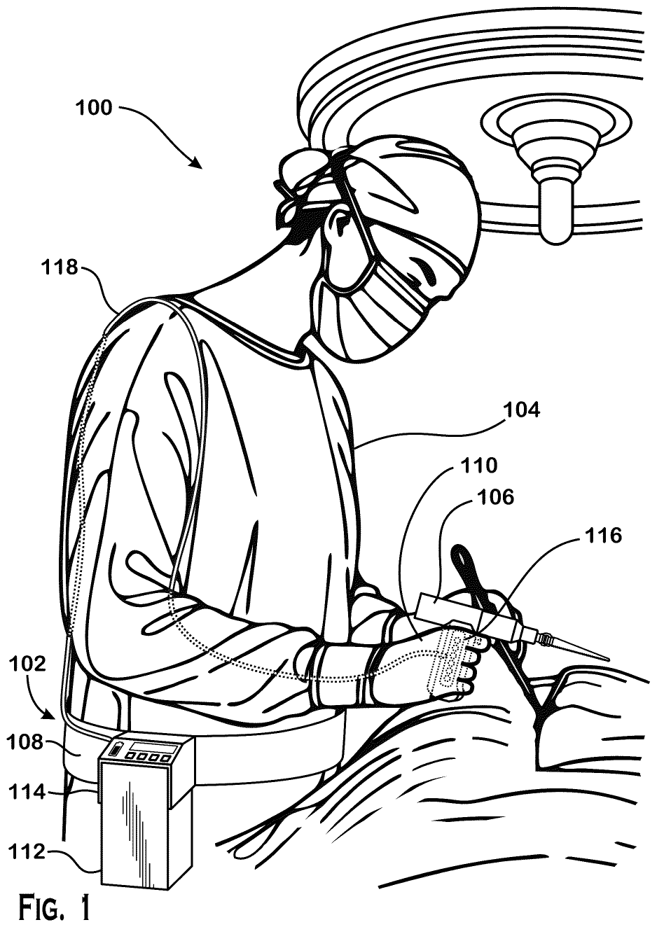

FIG. 1 shows an example of an environment 100 in which a wearable battery system 102 is used. The environment 100 is an operating room in which a surgeon 104 uses the wearable battery system 102 to power a saw 106. A portion of the wearable battery system 102 is shown to be attached to a belt 108 and another portion of the system 102 is shown to be attached to a glove 110. The portion attached to the belt 104 may include a majority of the weight of the system 102 (inclusive of attached battery(ies) 112). The portion attached to the belt 104 may be relatively heavy. Belt attachment offloads weight from the hands of the surgeon to the hip, thereby mitigating hand fatigue and freeing the hand for other tasks.

The wearable battery system 102 includes a housing 114 in which a battery management stage and a system control stage may be disposed, as described herein. The wearable battery system 102 includes a connector 116 that is operable to be coupled to the saw 106 and output power to the saw 106. The connector 116 is coupled to the housing 114 using a cable 118. The cable 118 may include conductors and communication lines as described herein.

It is noted that although the housing 114 is shown to be attached to a belt, it may be, additionally or alternatively, be attached to a backpack. Further, the connector 116 may alternatively be part of a hat, helmet, shirt or shoe, among others. In addition to or as an alternative to powering a surgical tool, the wearable battery system 102 may be used in a variety of environments to power construction, manufacturing and/or woodworking tools, among others.

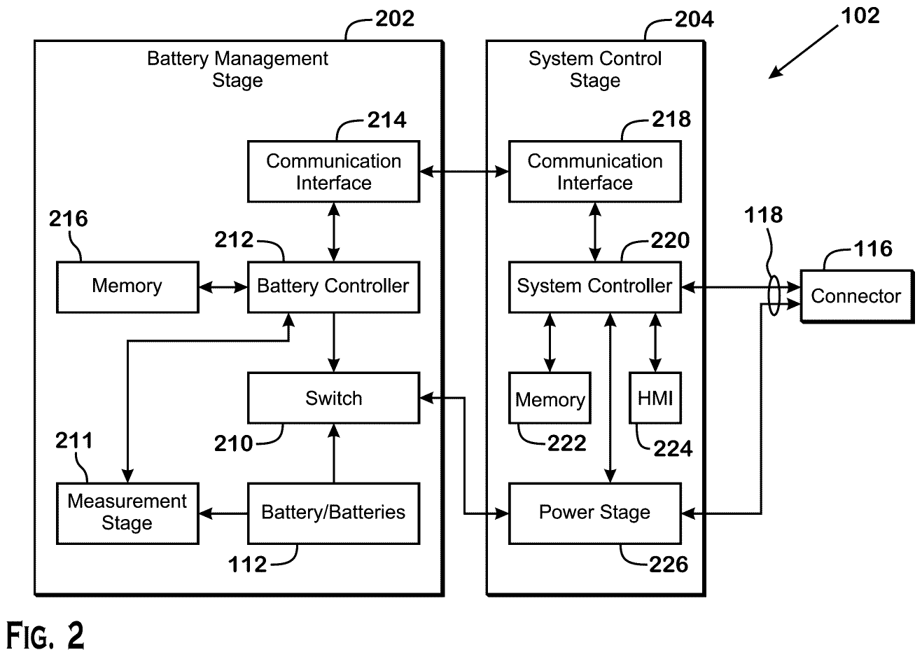

FIG. 2 shows a block diagram of the wearable battery system 102. The system includes a battery management stage 202, a system control stage 204 and a connector 116. The battery management stage 202 includes one or more batteries 116, a switch 210, a measurement stage 211, a battery controller 212, a communication interface 214 and a memory 216. The system control stage 204 includes a communication interface 218, a system controller 220, a memory 222, a human-machine interface (HMI) 224 and a power stage 226.

As described herein, the battery management stage 202 and the system control stage 204 may be worn. For example, the battery management stage 202 and the system control stage 204 may be attached to a belt or included in a backpack. The connector 116, however, may be part of a wearable garment, such as a glove, hat, helmet, shirt or shoe, among others.

The one or more batteries 116 may be lithium, sodium, cadmium or hydrogen batteries. Each battery may include one or more fuel cells. The one or more batteries 116 may be selectively couplable to the battery management stage 202. For example, the battery management stage 202 may include a receptacle (not shown) that is operable to receive the one or more batteries 116. The receptacle may take any form or shape such that it is configured to coupleably receive the one or more batteries 116.

The switch 210 operates to couple or decouple the one or more batteries 116 from the power stage 226 of the system control stage 204. The switch 210 is controlled by the battery controller 212. The battery controller 212 may send a signal to the switch 210 specifying whether the switch 210 should be in a closed state (as to be electrically conductive and supply power for the power stage 226) or an open state (as to be electrically isolated from the power stage 226). For example, the signal may be a binary signal.

The measurement stage 211 may include one or more electrical quantity sensors (such as, voltmeters, ammeters or multimeters, among others). The measurement stage 211 may determine a power measurement of the one or more batteries 116. The power measurement may be a voltage output of the one or more batteries 116, a current output of the one or more batteries 116, a state of charge (SOC) of the one or more batteries 116 or any combination thereof. The measurement stage 211 may output data indicative of the power measurement to the battery controller 212. The battery controller 212 may receive the data from the measurement stage 211 and determine based on the data whether to open or close the switch 210.

The memory 216 may include non-transitory memory, which may be read-only, programmable read-only or random access memory, among others. The non-transitory memory stores machine-readable instructions that when executed by the controller cause the controller to perform the techniques described herein. The machine-readable instructions may be one or more software or firmware programs or routines.

The battery controller 212 may include a data processing system, such as an Application Specific Integrated Circuit (ASIC), Field-Programmable Gate Array (FPGA), electronic circuit, central processing unit (CPU), arithmetic and logic unit (ALU) or a combination thereof. The battery controller 212 may include combinational logic circuits, input circuits (inputs), output circuits (outputs), signal conditioning circuits, buffers and other components, which may be accessed by and executed by the data processing system to perform the techniques described herein. The input and output circuits may include analog/digital converters and related devices that monitor inputs from sensors. Software, firmware, programs, instructions, control routines, code, algorithms and similar terms mean controller-executable instruction sets including calibrations and look-up tables. The controller may communicate using a direct wired point-to-point link, a networked communication bus link, a wireless link or any other type of communication technology. Communication includes exchanging data signals, including, for example, electrical signals via a conductive medium; electromagnetic signals via air; optical signals via optical waveguides; etc. The data signals may include discrete, analog and/or digitized analog signals representing inputs from sensors and communication between controllers. It is noted that although various functionality is described herein as being performed by different controllers or other devices, one controller may perform functionality of multiple controllers.

The communication interfaces 214, 218 may each be a communication device that enables communication between the battery controller 212 and the system controller 220. For example, the interfaces 214, 218 may each be a port that is compliant with the Inter-Integrated Circuit (I2C) protocol, among others. The communication interfaces 214, 218 may each include a transceiver. The communication interfaces 214, 218 may communicate in accordance with any wired or wireless communication protocol. The communication interface may be a cellular communications port that is capable of communicating over a cellular wireless network. The communication interface may also communicate in accordance any Institute for Electrical and Electronics Engineers (IEEE) 802 communication protocol or a lower-power Bluetooth or ZigBee protocol, or the like.

The system controller 220 may have a similar order or an identical structure as the battery controller 212 described herein. For example, the system controller 220 may include the data processing system and other components of the battery controller 212. The system controller 220 is coupled to the connector 116. The system controller 220 communicates, via the connector 116, with a tool. The system controller 220 may poll the tool, establish and maintain a keep-alive signal with the tool for continuous operation, request and receive a device identifier (DID) of the tool and perform error checking on incoming and outgoing data for data integrity. The system controller 220 may determine whether the device identifier matches an identifier of a plurality of identifiers stored in the memory 222. The system controller 220 may determine a voltage level, current level, power level or a combination thereof based on the device identifier. The system controller may command the power stage 226 to output the voltage level, current level, power level or a combination thereof to the tool.

The memory 222 may include non-transitory memory, which may be read-only, programmable read-only or random access memory, among others. The non-transitory memory stores machine-readable instructions that when executed by the system controller 220 cause the system controller 220 to perform the techniques described herein. The machine-readable instructions may be one or more software or firmware programs or routines. The memory 222 may store the plurality of identifiers. For each identifier, the memory 222 may store an associated voltage level, current level, power level, manufacturer name or identifier, model name or identifier and year of manufacture, among others.

The HMI 224 may be an input/output device. The HMI 224 may include a display (such as a touchscreen display), one or more input buttons (including a power button), one or more dials or the combination thereof. A user may use the HMI 224 to power on (or turn on) the system 102. The display may display information to the user graphically or using text. The information may include the SOC of the one or more batteries 116, where the SOC may be represented as a percentage charge. The information may include a low battery warning. The information may include the voltage level, current level, power level, manufacturer name or identifier, model name or identifier and year of manufacture of the tool.

The power stage 226 may include a converter, such as a DC-to-DC converter. The power stage 226 receives, via the switch 210, power that is output by the one or more batteries 116. The received power may be DC power. The power stage 226 receives, from the system controller 220, a specification of the voltage level, current level, power level or a combination thereof of the tool. The power stage 226 operates the converter to deliver the specified voltage, current and/or power. As described herein, the power stage 226 has an output coupled to the connector 116 over which the tool received the power. For example, the power stage may include a controller for the converter. The controller may operate the converter in accordance with the duty cycle that causes the specified voltage, current and/or power to be delivered to the tool.

The system controller 220 may communicate with the tool and may receive an indication of an error from the tool. The system controller 220 may cause the error to be output using the HMI 224. The system controller 220 may establish and maintain a keep-alive signal protocol with the tool and may receive a periodic alive signal from the tool. For example, if the system controller 220 determines that there is an error or that the alive signal has not been received, the system controller 220 may stop powering the tool. The system controller 220 may perform error check encoding and decoding on incoming and outgoing data for data integrity. It is noted that because the system 102 may be used in a sterile operating room environment, the system 102 may meet standards for operating room use.

The battery management stage 202 may perform real-time monitoring and control. For example, the battery controller 212 may send data indicating the state of charge, temperature or other parameters to the system controller 220. The data may be used to optimize battery performance, prevent overcharging or discharging and extend battery life. Additionally, the battery controller 212 may receive commands from the system controller 220 that enable coordinated control and management of the one or more batteries 112.

For example, the battery management stage 202 may include a temperature sensor that reports sensed temperatures to the battery controller 212. The battery controller 212 may turn off the switch 210 to implement overcurrent protection or over-temperature protection to ensure safe operation of the battery management stage 202. The battery management stage 202 may perform cell balancing and employ energy-efficient techniques to maintain a proper charge level of each cell of the one or more batteries 112. The battery management stage 202 may implement a fail-safe protocol in order to keep the cells of the one or more batteries 112 in a safe state in the event of a failure or malfunction of the system 102.

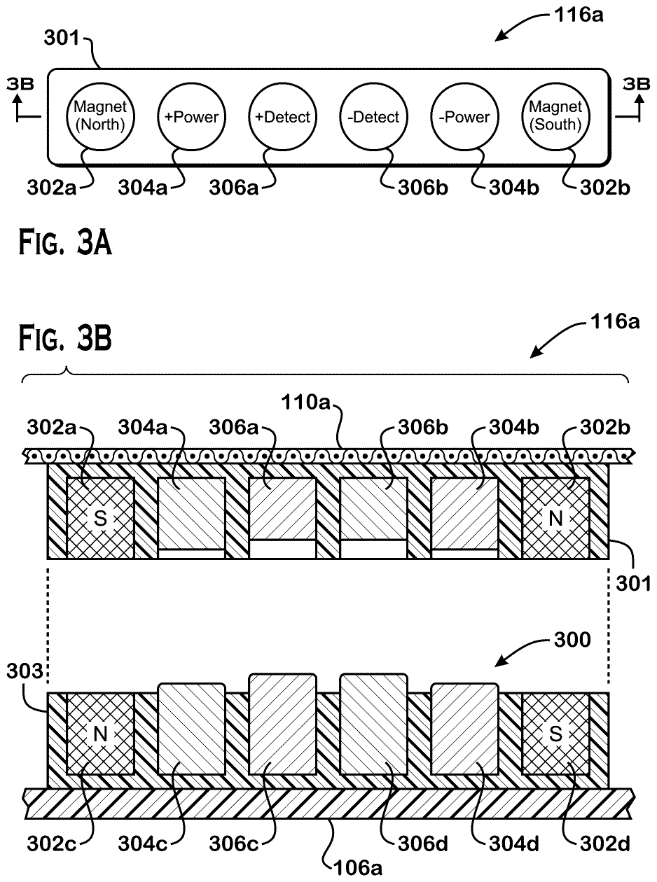

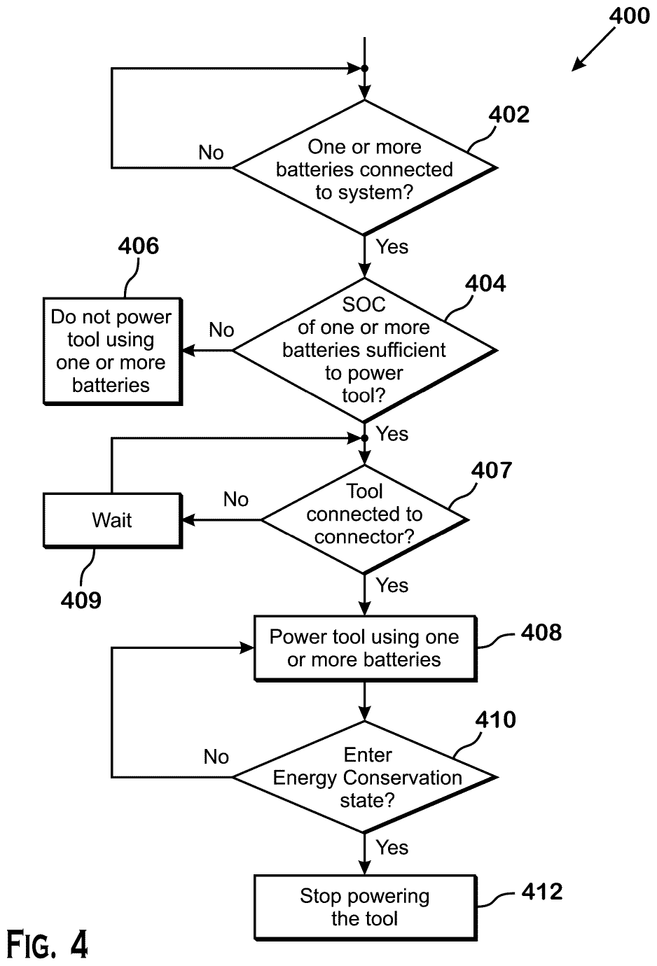

FIG. 3A shows a top view of the connector 116a and FIG. 3B shows a cross-sectional view of the connector 116a and an opposite polarity connector 300 in accordance with an embodiment. The connector 116a includes an insulator 301, and the connector 116a may be positioned on a wearable garment 110a. The insulator 301 electrically insulates from the garment 110 and the user wearing the garment 110a. For example, the connector 116a may be placed on a volar surface of a glove, a sole of a foot garment or an external surface of the head garment. The garment may be made of fabric, rubber or a resin, among others. The connector 116a may interface with the opposite polarity connector 300 of a tool 106a. Alternatively, the connector 116a may be a connector of the tool and the opposite polarity connector 300 may be used in the wearable garment.

The connector 116a includes first and second magnetic terminals 302a, 302b, first and second power terminals 304a, 304b and first and second signaling terminals 306a, 306b. The first and second magnetic terminals 302a, 302b may have opposite polarity, whereby the first magnetic terminal 302a may be a magnetic north and the second magnetic terminal 302b may be a magnetic south. The first and second magnetic terminals 302a, 302b are each operable to attract opposite polarity terminals 302c, 302d of the connector 300 of the tool 106a and enable coupling the connectors 116a, 300.

The first and second power terminals 304a, 304b provide power from the power stage 226 to the tool, whereby one of the power terminals 304a, 304b may be a positive DC terminal and another of the power terminals 304a, 304b may be a negative DC terminal. The first and second signaling terminals 306a, 306b enable communication between the system 102 (and the system controller 220 thereof) and the tool. The system 102 and the tool may use a data transmission protocol for exchanging data. The data transmission protocol may be a full-duplex, half-duplex or differential signaling protocol, among others. For example, the protocol may be I2C.

The heights or depressions of the pairs of terminals 302a, 302b, 304a, 304b, 306a, 306b may be different. For example, the first and second magnetic terminals 302a, 302b may be flush in relation to the insulator 301, whereas the first and second power terminals 304a, 304b may be depressed beyond the insulator 301 to a first distance. The first and second signaling terminals 306a, 306b may be depressed to a second distance that is greater than the first distance. To enable mating the connectors 116a, 300, the terminals 304c, 304d, 306c, 306d are correspondingly raised in relation to the insulator 303 to contact the first and second power terminals 304a, 304b and the first and second signaling terminals 306a, 306b. The connectors 116a, 300 improve user safety while also being durable enough to allow for hot unplugging without compromising safety.

The first power terminal 304a is coupled using a first wire to the power stage 226, and the second power terminal 304b is coupled using a second wire to the power stage 226. The first signaling terminal 306a is coupled using a first communication line to the system controller 220, and the second signaling terminal 306b is coupled using a second communication line to the system controller 220. The wires and communication lines are carried in the cable 118.

The connector 116a may be a universal connector for tools that are compatible with the wearable battery system 102. For example, each compatible tool may have a connector 300 that is also universal and that has an opposite polarity to the connector 116a. Alternatively, each group (or class) of tools or wearable garments may have it own connector that is unique and universal to the group, and the connector for the group may be different than connectors for other groups of tools or garments. For example, connectors attached to a glove may be different than those attached to a shoe, hat, or helmet. Alternatively, tools may be grouped by industry usage. For example, surgical tools may have different a different connector than landscaping/gardening, construction or sports tools.

As described herein, the connector 116a is connected to a housing 114 of the wearable battery system 102 via a cable 118. The cable 118 may be group-specific and may be connectable to the housing 114 via a cable connector as described herein. To utilize the wearable battery system 102 on tools of different groups, a user may detach the cable and connector of a first group from the housing 114 and attach the cable and connector of a second group to the housing 114. Alternatively, the cable 118 may also be universal. In some embodiments, the cable 118 may be configured to become taut in use. For example, the cable 118 may be biased in a certain direction, e.g., via springs, pulleys, or any cable tensioning device, such that any undesired slack may be mitigated. To utilize the wearable battery system 102 on tools of different groups, a user may detach the connector of a first group from the cable 118 and attach the connector of a second group to cable 118.

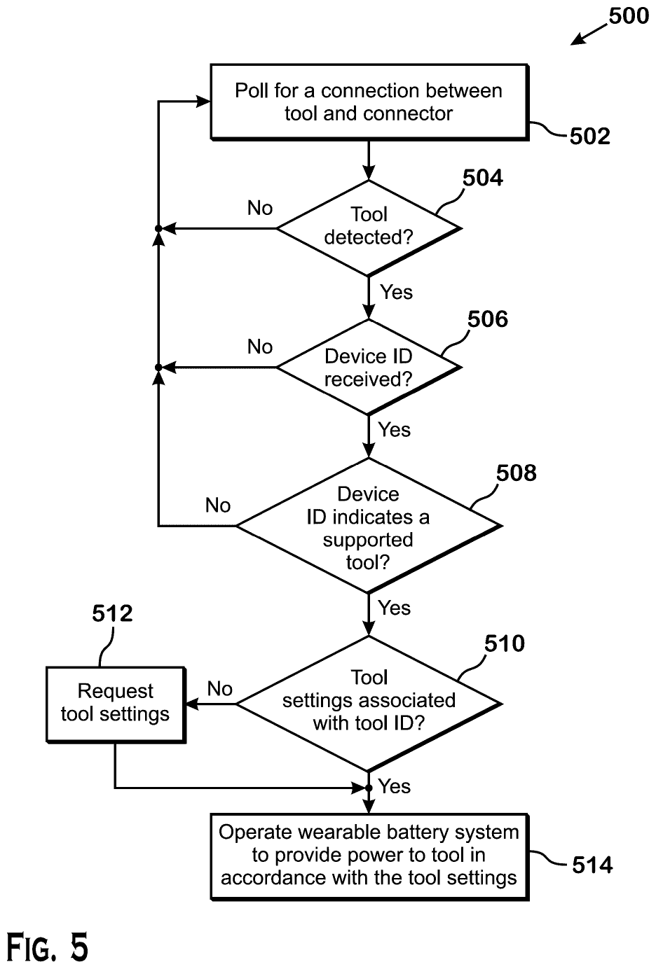

FIG. 4 shows a flow diagram of a method 400 for operating the wearable battery system 102 in accordance with an embodiment. A user may use the HMI 224 (e.g., a power button on the HMI 224) to turn on the wearable battery system 102. It is noted that the wearable battery system 102 may rely on power provided by the one or more batteries 116 to enable operation. Additionally or alternatively, the wearable battery system 102 may include an auxiliary power source (such as, a built-in rechargeable battery), and the auxiliary power source may provide power to the system 102 when the one or more batteries 116 are not connected to the system 102 or when the SOC of the one or more batteries 116 is too low to provide stable power to the system 102. The auxiliary power source may be recharged using power from the one or more batteries 116.

In the method 400, the battery controller 212, at 402, determines whether the one or more batteries 116 are connected to the system 102. The battery controller 212 may determine that the one or more batteries 116 are connected to the system 102 if the battery controller 212 receives data indicative of a power measurement from the measurement stage 211. The battery controller 212 may determine that the one or more batteries 116 are connected to the system 102 if the battery controller 212 receives data indicating that the user connected the one or more batteries 116. The battery controller 212 may receive the data from the system controller 220. The system controller 220 may send the data to the battery controller 212 in response to the system controller 220 receiving user input, via the HMI 224, specifying that the one or more batteries 116 have been connected. The battery controller 212 may determine that the one or more batteries 116 are connected to the system 102 if the battery controller 212 receives a signal indicating that a physical switch operative to couple the one or more batteries 116 to the system 102 has been transitioned to the conductive state. The physical switch may be different than the switch 210. The physical switch may be provided such that the user may actuate the physical switch after inserting the one or more batteries 116 in the system 102. For example, the physical switch may also hold the one or more batteries 116 in place. The battery controller 212 may be coupled to the physical switch. In response to the user actuating the physical switch, the physical switch may send the signal to the battery controller 212 indicating that the one or more batteries 116 been coupled to the system 102. The battery controller 212 may determine that the one or more batteries 116 are connected to the system 102 if one criterion or more than one criteria of the following criteria are satisfied: (i) the battery controller 212 receives data indicative of a power measurement from the measurement stage 211; (ii) the battery controller 212 receives data indicating that the user connected the one or more batteries 116; and (iii) the battery controller 212 receives a signal indicating that a physical switch operative to couple the one or more batteries 116 to the system 102 has been transitioned to the conductive state.

If a positive determination is made, the battery controller 212, at 404, determines whether the SOC of the one or more batteries 116 is sufficient to power the tool. The battery controller 212 determines that the SOC of the one or more batteries 116 is sufficient to power the tool if one or more criteria are met. A first criterion is met if the SOC is greater than an SOC threshold. For example, the SOC threshold may be a percentage, such as, 10%, 15% or 20%, among others. A second criterion is met if the SOC is sufficient to power the tool for a minimum period of time, whereby the minimum period of time may be 10 minutes, 30 minutes or one hour, among others. Evaluation of the second criterion utilizes the power consumption of the tool as determined based on the device identifier described herein. For example, the battery controller 212 may receive from the system controller 220 data indicating a level of power consumption of the tool. The battery controller 212 may then determine a duration of time that the SOC may power the tool at the level of power consumption. The second criterion may be met if the duration of time is greater than the minimum period of time. Alternatively, the second criterion may be conditioned on the SOC remaining after above the SOC threshold for the minimum period of time. That is, the second criterion may not be satisfied if after powering the tool for the minimum duration of time the SOC of the battery drops below the SOC threshold. The battery controller 212 may make a positive determination if the first criterion is met, the second criterion is met or board for the first and second criteria are met.

If a negative determination is made at 404, the battery controller 212, at 406, refrains from powering the tool using the one or more batteries 116. The battery controller 212 may cause the HMI 224 to output a message to the user indicating that the SOC is insufficient and specifying the criterion that has not been met.

If a positive determination is made at 404, the battery controller 212 determines, at 407, whether the tool is connected to the connector 116. As described herein, the system controller 220 polls the tool to determine whether the tool is connected to the connector 116. In response to determining that the tool is connected, the system controller 220 may send data to the battery controller 212 indicating the connectivity.

If a negative determination is made at 407, the battery controller 212 waits, at 409, to receive the indication from the system controller 220. If a positive determination is made at 407, the battery controller 212, at 408, powers the tool using the one or more batteries 116. Powering the tool may include transitioning the switch 210 to a conductive state to cause the one or more batteries 116 to output power to the power stage 226. The battery controller 212 may send data to the system controller 220 indicating that the switch 210 is transitioned to the conductive state and/or that the one or more batteries 116 are ready to power the tool. The system controller 220 commands the power stage 226 to convert a voltage level, current level, power level or a combination thereof received from the one or more batteries 116 to a level or levels corresponding to the device identifier of the tool.

Before powering the tool, the battery controller 212 may perform a system diagnostic procedure or test to assess a functionality of the battery management stage 202. Powering the tool may be contingent on the battery management stage 202 passing the system diagnostic procedure or test.

The battery controller 212, at 410, determines whether to enter an energy conservation state. The battery controller 212 may determine to enter the energy conservation state in response to user input. For example, the user may use the HMI 224 to provide an input to the system 102 activating the energy conservation state. The system controller 220 may receive, from the HMI 224, data indicating that the user input has been provided, and the system controller 220 may send data to the battery controller 212 indicating that the user input has been provided.

If the battery controller 212 makes a positive determination at 410, the battery controller 212 stops powering the tool at 412 (e.g., by opening the switch 212 and/or causing the power stage 226 to cease power conversion or cease outputting current or voltage to the tool). If the battery controller 212 makes negative determination at 410, the battery controller 212 continues powering the tool.

FIG. 5 shows a flow diagram of a method 500 for operating the wearable battery system 102 in accordance with an embodiment. The method 500 includes the system controller 220 polling, at 502, for a connection between the tool and the connector 116. As described herein, the first and second signaling terminals 306a, 306b of the connector 116 are coupled to the system controller 220 using two communication lines. The system controller may poll by detecting an impedance between the first and second signaling terminals 306a, 306b, awaiting reception, over the terminals 306a, 306b, of a response signal to a polling signal that is transmitted over the terminals 306a, 306b, awaiting reception, over the terminals 306a, 306b, a polling signal transmitted by the tool, or a combination thereof. The system controller 220 may perform the polling continuously or at regular or irregular time intervals.

The system controller 220 determines, at 504, whether the tool is detected. The system controller 220 determines that the tool is detected if one or more criteria are met. A first criterion is met if a detected impedance between the signaling terminals 306a, 306b is within a range of impedance values. When the signaling terminals 306a, 306b are electrically isolated (as is the case when the signaling terminals 306a, 306b are not connected by a conductor and are separated by air, which has a resistivity between 10⁹ and 10¹⁵ Ω·m), the impedance between the signaling terminals 306a, 306b is expected to be very large (or theoretically infinity). Conversely, if the signaling terminals 306a, 306b become wet or are touched by human skin, the impedance between the signaling terminals 306a, 306b is expected to be relatively low due to the low resistivities of drinking water and the human body, which may range from 20 to 2000 Ω·m. If the distance between the signaling terminals 306a, 306b is 0.01 m, then the range of impedance values may be set to 20 to 10⁷Ω. The first criterion is not met if the impedance between the signaling terminals 306a, 306b is less than 20Ω as the low impedance suggests that a user touched the terminals or the connector 116 is wet. The first criterion is not met if the impedance between the signaling terminals 306a, 306b is greater than 10⁷Ω as the high impedance suggests that the terminals are not coupled to a tool. Use of the range of impedance values prevents inadvertently powering the power terminals 304a, 304b. The system 102 may include an impedance measurement device that is coupled to the signaling terminals 306a, 306b and operative to measure the impedance between the terminals and output the measured impedance to the system controller 220.

A second criterion may be met if the system controller 220 receives a polling response signal over the first signaling terminal 306a, second signaling terminal 306b or both terminals. The system controller 220 may transmit a polling signal over the first and/or second signaling terminals 306a, 306b. When the system 102 is powered, the system controller 220 may transmit the polling signal periodically (e.g., every one second or two seconds, among others). The polling signal may have a particular signature (e.g., digital bit pattern or analog signal pattern). The tool, when connected to the connector 116 and signaling terminals 306a, 306b thereof, receives the polling signal. If the tool is interoperable with the system 102, the tool may be configured to recognize the polling signal based on its signature. The tool may be configured to respond to the polling signal with a polling response signal. The polling response signal may also have a particular signature that may be different from the signature of the polling signal. For example, tools that are interoperable with the wearable battery system 102 may be configured to both detect the signature of the polling signal and respond with the polling response signal of a particular signature. In addition to the signature, which may be a bit pattern included as part of the polling response signal, the polling response signal may include the device identifier of the tool. The device identifier may be an alphanumeric bit string unique to the tool. For example, the polling response signal may be a digital signal having the signature as a header and the device identifier as a payload.

A third criterion may be met if the system controller 220 receives, over the terminals 306a, 306b, a polling signal transmitted by the tool. The polling signal may be initiated by the tool (or a controller thereof). Similar to the polling response signal, the polling signal may have a particular signature (e.g., digital bit pattern or analog signal pattern). The system controller 220 may determine that the third criterion is met if the polling signal has signature that matches a known signature stored by the system controller 220. In addition to the signature, which may be a bit pattern included as part of the polling signal, the polling signal may include the device identifier of the tool.

In response to making a negative determination at 504, the system controller 220 continues to poll for the connection at 502. Additionally or alternatively, the system controller 220 may cause the HMI 224 to display a message indicating that the tool has not been detected. In response to making a positive determination at 504, the system controller 220 determines whether a device identifier for the tool has been received at 506. The device identifier may be received in a polling signal, a polling response signal or a different signal that includes the device identifier. The system controller 220 may send a signal to the tool requesting the device identifier, and the tool may respond to the signal and send the device identifier to the system controller 220.

In response to making a negative determination at 506, the system controller 220 reverts to polling for a connection or determining whether the tool is detected. For example, the system controller 220 may retransmit the signal requesting the device identifier and may receive another response from the tool. Additionally or alternatively, the system controller 220 may cause the HMI 224 to display a message to the user indicating that the device identifier has not been received.

In response to making a positive determination at 506, the system controller 220, at 508, determines whether the device identifier indicates a supported tool. The tool may be supported if the device identifier matches a device identifier in a list of device identifiers retained by the system controller 220.

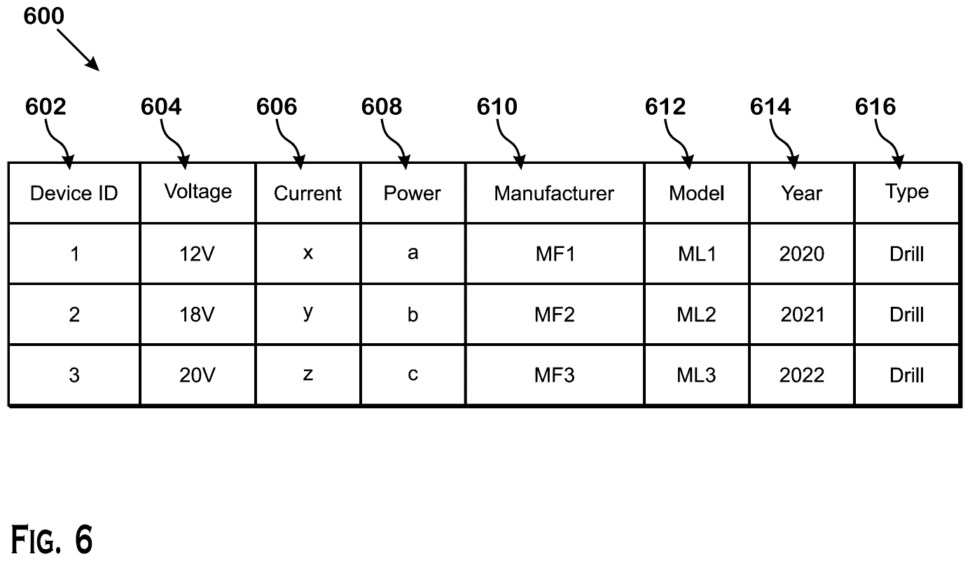

FIG. 6 shows an example of a list 600 of device identifiers 602 retained by the system controller 220. For each identifier 602, the memory 222 may store an associated voltage level 604, current level 606, power level 608, manufacturer name or identifier 610, model name or identifier 612, year of manufacture 614 and type of tool 616. The system controller may access the list 600 and the memory 222 and determine whether a received device identifier is among the identifier 602 of the list 600. If so, the system controller 220 determines that the device identifier indicates a supported tool.

Referring back to FIG. 5, if the system controller 220 makes a negative determination at 508, the system controller 220 reverts to polling for a connection, determining whether a tool is detected or determining whether a device identity has been received. Additionally or alternatively, the system controller 220 may command the HMI 224 to display a message to the user indicating that the connected tool is not a supported tool.

If the system controller 220 makes a positive determination at 508, the system controller 220, at 510, determines whether tool settings associated with the device identity have been found. The tool settings may be deemed to be found if the name list 600 associates a voltage level, current level, power level or a combination thereof with the tool identity. The tool settings are used to control the power output of the wearable battery system 102.

If the system controller 220 makes a negative determination at 510, the system controller 220, at 512, requests the tool settings from the user. For example, the system controller 220 may cause a message to be displayed on the HMI 224 requesting that the user enter the tool settings using the HMI 224. The user may use buttons, dials, a touchscreen display or a combination thereof of the HMI 224 to enter the tool settings.

If the system controller 220 makes a positive determination at 510 or if the user provides the tool settings using the HMI 224, the system controller 220, at 514, operates the wearable battery system 102 to provide power to the tool in accordance with the tool settings. As described herein, the system controller 220 commands the power stage 226 to output a specified voltage level, current level, power level or a combination thereof to the tool. The power stage 226 (e.g., in response to system controller 220 command) may output the voltage level, current level, power level or combination to be within a margin (e.g., +/−0.5%, 1%, 2% or 5%) of the stored settings.

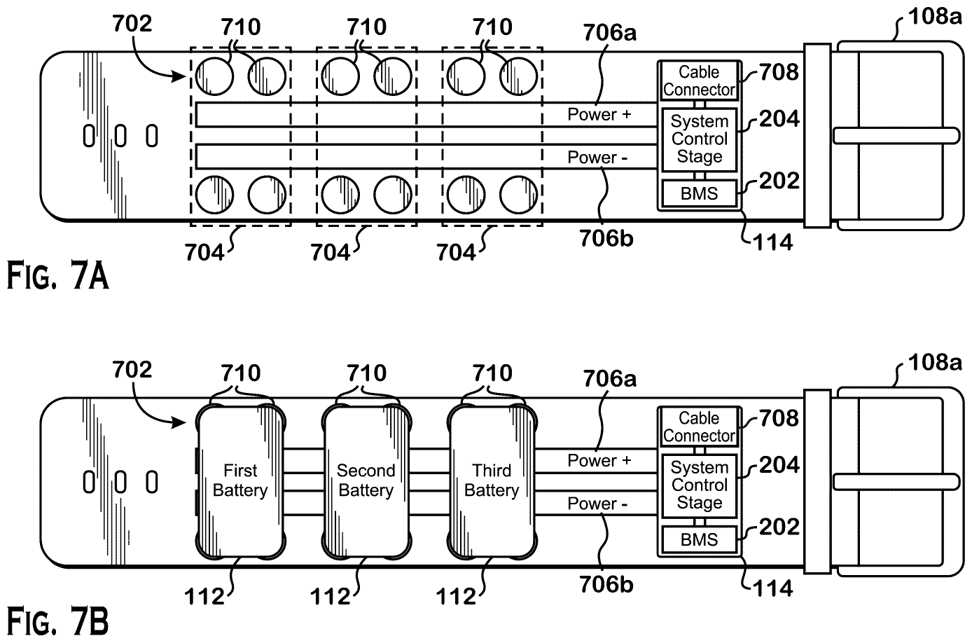

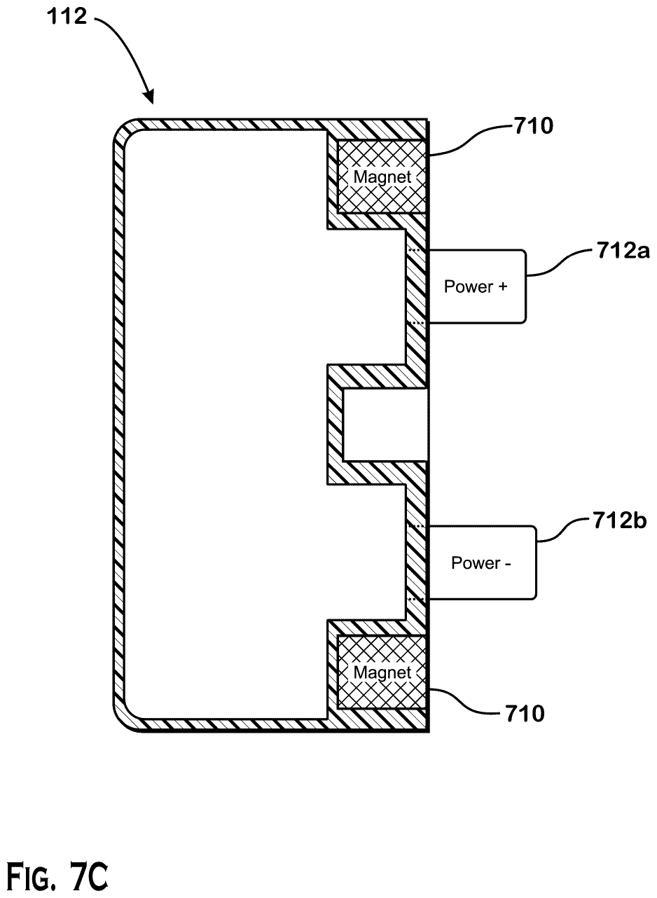

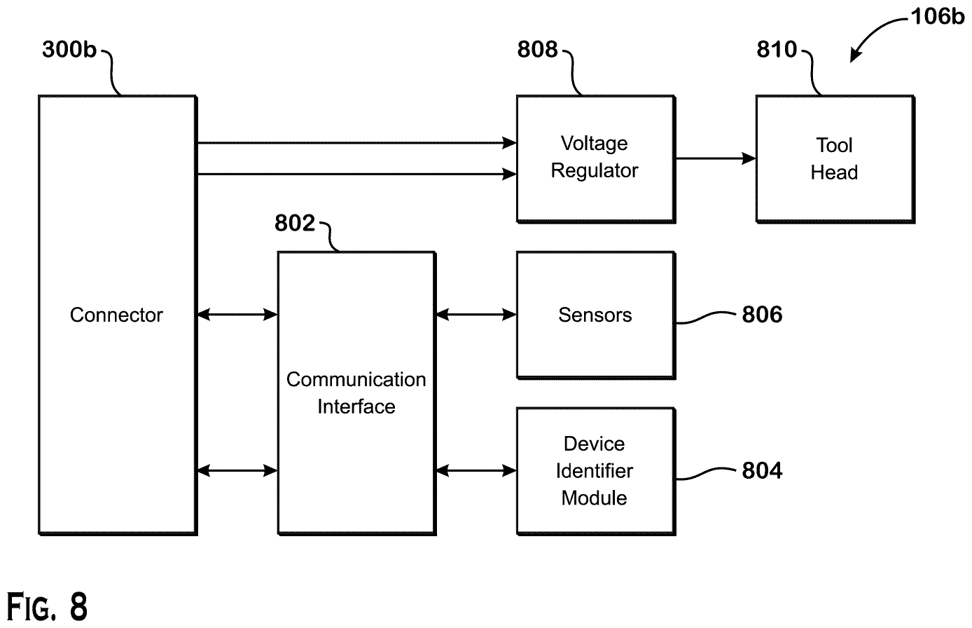

FIG. 7A shows a top view of a belt 108a having a battery connector 702 and the housing 114 of the wearable battery system 102 attached thereto. FIG. 7B shows a top view of the belt 108a of FIG. 7A having batteries 112 coupled thereto.

The battery connector 702 includes a plurality of sets of magnets 704. Each set of magnets 704 is operable to attract a corresponding set of magnets of a battery 112. Each set of magnets 704 may include magnets of the same polarity. Or, the magnets of a set may have different polarities. The battery 112 has a corresponding set of opposite polarity magnets, where each battery magnet has an opposite polarity of a respective belt magnet. The battery connector 702 includes two conductive terminals 706a, 706b for making a DC power connection to a battery 112. For example, the conductive terminals 706a, 706b are coupled to the battery management stage 202 and components thereof. The housing 114 includes a cable connector 708 for coupling the cable 118 to the system 102.

FIG. 7C shows a cross-sectional view of a battery 112. The battery 112 has magnets 710 for attachment to the belt 108a. The battery 112 has DC power terminals 712a, 712b that respectively contact the conductive terminals 706a, 706b of the belt 108a.

FIG. 8 shows a simplified block diagram of the tool 106b. The tool 106b includes a connector 300b, a communication interface 802, a device identifier module 804, one or more sensors 806, a voltage regulator 808 and a tool head 810. The connector 300b is operable to make connect to a connector of the wearable battery system 102 as described herein. The communication interface 802 may be similar to the communication interfaces 214, 218 described herein and may be any type of communication port or transceiver that communicates data.

The device identifier module 804 may be memory configured to store the device identifier and provide the device identifier to the battery power system as described herein. For example, the device identifier module 804 may be a register, ROM or SDRAM, among others. Further, the device identifier module 804 may be a hardware security module (HSM), such as a SmartCard-HSM. The device identifier stored by the device identifier module 804 may not be modified by users after the manufacturing of the tool. For example, the device identifier module 804 may require a specific key to be provided to modify the stored device identifier. The device identifier module 804 may prevent the device identifier from being changed for a specified minimum shelf life of the tool.

The one or more sensors 806 may include a thermometer, ammeter, voltmeter, multimeter or tachometer, among others. The one or more sensors 806 may be configured to sense a condition or an electrical quantity of the tool 106b and send a measurement of the condition or quantity to the wearable battery system 102. The voltage regulator 808 may be configured to receive a voltage from the system 102, regulate the voltage to maintain a substantially constant voltage and output the regulated voltage to the tool head 810. The tool head 810 may be a motor of the tool 106b.

The one or more sensors 806 may send diagnostic information about the tool to the wearable battery system 102. For example, the one or more sensors 806 may send a measurement of a temperature, power consumption, speed, torque or a combination thereof to the wearable battery system 102. The system 102 may evaluate the measurements to determine tool health and stop power supply to the tool, e.g., if the temperature, power consumption, speed and/or torque are higher than respective thresholds. For example, the system 102 may store, for each device identifier, thresholds for the temperature, power consumption, speed and torque. If one or multiple measurements exceed the respective thresholds, the system 102 may terminate power supply.

It is noted that the system 102 and tool 106 (or the connectors 116, 300 thereof) may include proximity sensors that detects a proximity of the system 102 and tool 106 or that a connection between the system 102 and tool 106 has been made. Polling the tool, requesting the device identifier and/or supplying power to the tool may be contingent on detection of a proximity between the system 102 and tool 106.

Provided is a system for powering a tool (e.g., hand holdable electric or electromotive device) to be used by a user. The system may include a wearable belt having a first conductive strip and a second conductive strip and a battery releasably coupleable to the conductive strips and sized and structured so that a positive terminal on the battery is capable of coupling with the first conductive strip and a negative terminal on the battery is capable of coupling with the second conductive strip. The system determines a voltage and/or an amperage of the tool and outputs the voltage and/or to the tool, thereby allowing the battery to power a variety of different tools with different voltage and amperage requirements.

The battery includes one or more battery magnets and the belt further includes one or more belt magnets, where the one or more battery magnets and the one or more belt magnets are sized and structured to be substantially aligned such that the battery can be releasably magnetically coupled to the belt.

The belt is structured to be wearable by the user and have opposing first and second sides. The first side is designed to face away from the user when worn by the user, and the first side has one or more pairs of magnets. A first magnet has a north pole that faces away from the user, and a second magnet has a south pole that faces away from the user. The first side of the belt has a first conductive strip and a second conductive strip, where the strips are coupled to the belt such that they are substantially aligned with the one or more pairs of magnets.

The battery may have a surface and one or more pairs of battery magnets. A first battery magnet has a north pole that is accessible via the surface of the battery and a second battery magnet has a south pole that is accessible via the surface of the battery. The one or more pairs of battery magnets are sized and structured to substantially align with the one or more pairs of magnets on the belt, such that the battery can be releasably magnetically coupled to the belt, and further so that a positive terminal of the battery can couple with the first conductive strip and a negative terminal of the battery can couple with the second conductive strip.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable battery system, comprising:
a battery connector operable to make electrical contact with one or more batteries;
a tool connector operable to make electrical contact with a tool; and
a system controller configured to:
poll for a connection between the wearable battery system and the tool;
receive, over the connection, a device identifier of the tool;
access a plurality of stored device identifiers, each stored device identifier of the plurality of stored device identifiers being associated with a voltage level and a current level;
determine whether the device identifier corresponds to a stored device identifier of the plurality of stored device identifiers;
in response to determining that the device identifier does not correspond to the stored device identifier of the plurality of stored device identifiers, refrain from supplying power from the one or more batteries to the tool; and
in response to determining that the device identifier corresponds to the stored device identifier of the plurality of stored device identifiers,
retrieve the voltage level and the current level associated with the stored device identifier;
set an output voltage of the wearable battery system to the voltage level associated with the stored device identifier and an output current of the wearable battery system to the current level associated with the stored device identifier; and
cause power to be supplied from the one or more batteries to the tool in accordance with the output voltage and the output current.

2. The wearable battery system of claim 1, wherein each stored device identifier of the plurality of stored device identifiers is associated with a name of a manufacturer of the tool, a model number of the tool, a year of manufacturing of the tool and a type of the tool.

3. The wearable battery system of claim 1, wherein polling for the connection includes determining whether one or more criteria of a plurality of criteria are met, the plurality of criteria including:
a first criterion that is met if a detected impedance between signaling terminals of the tool connector is within a range of impedance values;
a second criterion that is met if a polling response signal is received over first or second signaling terminals of the tool connector; and
a third criterion that is met if a polling signal is received from the tool over the first or second signaling terminals of the tool connector.

4. The wearable battery system of claim 1, comprising:
a battery controller configured to:
determine that a state of charge (SOC) of the one or more batteries is sufficient to power the tool in response to one or more criteria of a plurality of criteria being met, the plurality of criteria including:
a first criterion that is met if the SOC is greater than an SOC threshold;
a second criterion that is met if the SOC is sufficient to power the tool for a minimum period of time; and
a third criterion that is met if the SOC remaining after the minimum period of time is greater than the SOC threshold.

5. The wearable battery system of claim 1, comprising:
a battery controller configured to:
determine that the one or more batteries are connected to the battery connector in response to one or more criteria of a plurality of criteria are met, the plurality of criteria including:
a first criterion that is met if the battery controller receives data indicative of a power measurement from a measurement stage;
a second criterion that is met if the battery controller receives data indicating that a user connected the one or more batteries; and
a third criterion that is met if the battery controller receives a signal indicating that a physical switch operative to couple the one or more batteries to the battery connector has transitioned to a conductive state.

6. The wearable battery system of claim 1, wherein the tool connector is a universal connector that is compatible with a plurality of tools including the tool.

7. The wearable battery system of claim 1, wherein the battery connector is positioned on a belt, shoulder harness or back pack, and the tool connector is positioned on a hand garment, foot garment, or head garment.

8. The wearable battery system of claim 1, wherein the system controller is configured to receive the device identifier from a hardware security module (HSM) of the tool.

9. The wearable battery system of claim 1, wherein the system controller is configured to:
receive a measurement of a temperature, power consumption, speed or torque of the tool;
determine whether the measurement exceeds a threshold; and
in response to determining that the measurement exceeds the threshold, cease supplying the power to the tool.

10. A method, comprising:
polling, by a system controller, for a connection between a wearable battery system and a tool;
receiving, over the connection, a device identifier of the tool;
accessing a plurality of stored device identifiers, each stored device identifier of the plurality of stored device identifiers being associated with a voltage level and a current level;
determining whether the device identifier corresponds to a stored device identifier of the plurality of stored device identifiers;
in response to determining that the device identifier does not correspond to the stored device identifier of the plurality of stored device identifiers, refraining from supplying power from one or more batteries to the tool; and
in response to determining that the device identifier corresponds to the stored device identifier of the plurality of stored device identifiers,
retrieving the voltage level and the current level associated with the stored device identifier;
setting an output voltage of the wearable battery system to the voltage level associated with the stored device identifier and an output current of the wearable battery system to the current level associated with the stored device identifier; and
causing power to be supplied from the one or more batteries to the tool in accordance with the output voltage and the output current.

11. The method of claim 1, wherein each stored device identifier of the plurality of stored device identifiers is associated with a name of a manufacturer of the tool, a model number of the tool, a year of manufacturing of the tool and a type of the tool.

12. The method of claim 1, wherein polling for the connection includes determining whether one or more criteria of a plurality of criteria are met, the plurality of criteria including:
a first criterion that is met if a detected impedance between signaling terminals of a tool connector is within a range of impedance values;
a second criterion that is met if a polling response signal is received over first or second signaling terminals of the tool connector; and
a third criterion that is met if a polling signal is received from the tool over the first or second signaling terminals of the tool connector.

13. The method of claim 12, wherein the tool connector is a universal connector that is compatible with a plurality of tools including the tool.

14. The method of claim 9, comprising:
determining that a state of charge (SOC) of the one or more batteries is sufficient to power the tool in response to one or more criteria of a plurality of criteria being met, the plurality of criteria including:
a first criterion that is met if the SOC is greater than an SOC threshold;
a second criterion that is met if the SOC is sufficient to power the tool for a minimum period of time; and
a third criterion that is met if the SOC remaining after the minimum period of time is greater than the SOC threshold.

15. The method of claim 9, comprising:
determining that the one or more batteries are connected to a battery connector in response to one or more criteria of a plurality of criteria are met, the plurality of criteria including:
a first criterion that is met if the battery controller receives data indicative of a power measurement from a measurement stage;
a second criterion that is met if the battery controller receives data indicating that a user connected the one or more batteries; and
a third criterion that is met if the battery controller receives a signal indicating that a physical switch operative to couple the one or more batteries to the battery connector has transitioned to a conductive state.

16. The method of claim 15, wherein the battery connector is positioned on a belt, shoulder harness or back pack, and the tool connector is positioned on a hand garment, foot garment, or head garment.

17. The method of claim 9, comprising:
receiving the device identifier from a hardware security module (HSM) of the tool.

18. The method of claim 9, comprising:
receiving a measurement of a temperature, power consumption, speed or torque of the tool;
determining whether the measurement exceeds a threshold; and
in response to determining that the measurement exceeds the threshold, ceasing supplying the power to the tool.

19. A system, comprising:
a tool; and
a wearable battery system including:
a battery connector operable to make electrical contact with one or more batteries;
a tool connector operable to make electrical contact with the tool; and
a system controller configured to:
poll for a connection between the wearable battery system and the tool;
receive, over the connection, a device identifier of the tool;
access a plurality of stored device identifiers, each stored device identifier of the plurality of stored device identifiers being associated with a voltage level and a current level;
determine whether the device identifier corresponds to a stored device identifier of the plurality of stored device identifiers;
in response to determining that the device identifier does not correspond to the stored device identifier of the plurality of stored device identifiers, refrain from supplying power from the one or more batteries to the tool; and
in response to determining that the device identifier corresponds to the stored device identifier of the plurality of stored device identifiers,
retrieve the voltage level and the current level associated with the stored device identifier;
set an output voltage of the wearable battery system to the voltage level associated with the stored device identifier and an output current of the wearable battery system to the current level associated with the stored device identifier; and
cause power to be supplied from the one or more batteries to the tool in accordance with the output voltage and the output current.

20. The system of claim 19, wherein the tool connector is a universal connector that is compatible with a plurality of tools including the tool, the battery connector is positioned on a belt, shoulder harness or back pack, and the tool connector is positioned on a hand garment, foot garment, or head garment.
